(19) United States
(12) Patent Application Publication
(10) Pub. No.: US 2012/0173396 A1
(43) Pub. Date: Jul. 5, 2012

(54) BILL DIVISION AND GROUP PAYMENT SYSTEMS AND METHODS

(75) Inventors: Michael J. MELBY, Newport Beach, CA (US); Raymond Tamblyn, New York, NY (US); Samuel Whitaker, Philadelphia, PA (US)

(73) Assignee: PAYDIVVY, INC., Irvine, CA (US)

(21) Appl. No.: 12/981,941

(22) Filed: Dec. 30, 2010

(51) Int. Cl. G06Q 30/00; G06Q 40/00

(52) U.S. Cl. 705/34; 705/40

(57) ABSTRACT

Systems and methods for dividing a group bill among users, collecting funds from the users, and paying a third party with the collected funds using a group billing system. Users may have individual accounts associated with the group billing system. The individual accounts may be associated with a prepaid credit or debit card, or other payment vehicle.

### BACKGROUND

In a wide variety of situations two or more people may need to share or otherwise divide a bill, an expense, or other amount that is owed. Such group payment situations may occur in the context of rent, utility and other home services bills (e.g., cable, internet, telephone, etc.), social event bills (e.g., travel, restaurant, bar, etc.), and retail purchases of goods and services, for example.

For example, roommates frequently encounter the need to apportion rent and utility bills. In social outings, it sometime is desirable to receive a single bill from an establishment instead of receiving individual bills for each person in a group. Also, organizations may pool member funds together for joint purchases. In each case, since more than one person must contribute funds toward a single bill or expense, the amount of the bill or expense is typically split amongst the individual members of the group.

### BRIEF DESCRIPTION OF THE DRAWINGS

The present disclosure will be more readily understood from a detailed description of some example embodiments taken in conjunction with the following figures:

FIG. 1 illustrates an example computer-based group billing system in accordance with one non-limiting embodiment.

FIG. 2 illustrates a flowchart of an example group billing process in accordance with one non-limiting embodiment.

FIG. 3 illustrates a flowchart of an example group billing process for a previously paid bill in accordance with one non-limiting embodiment.

FIGS. 4 and 5 illustrate flowcharts of an example group bill payment processes which include a fee structure in accordance with non-limiting embodiments.

FIG. 6 illustrates a flowchart of an example group billing process with a reoccurring group bill in accordance with one non-limiting embodiment.

FIGS. 7-8 are diagrams of an example user interface in accordance with one non-limiting embodiment.

### DETAILED DESCRIPTION

Various non-limiting embodiments of the present disclosure will now be described to provide an overall understanding of the principles of the structure, function, and use of the group billing systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The presently disclosed embodiments are generally directed to group (i.e., two or more people) payment systems and methods. Such systems and methods may be implemented in a wide variety of contexts. In one example embodiment, the presently disclosed system and methods allow for roommates to collectively manage a variety of bills and expenses, such as rent and utility bills. The status of the bills, the amount owed per person, and other types of information may be displayed on a user interface that is accessible via a networked device. Each roommate may monitor the status of the bills and individually pay their portion of the outstanding bills. The portion of a bill owed by a particular roommate may be equal to or different than the portions that other roommates pay. For example, roommates may equally split the monthly rent bill while splitting a telephone bill based on the individual usage. In any event, the group billing system of the presently disclosed embodiment coordinates and centralizes the collection the funds from the individual roommates and then transfers funds to a third party, such as the landlord or the utility company, for example. As discussed in more detail below, individual roommates may provide funds to the group billing system via any suitable fund transfer technique, such as via a credit or debit card or via an electronic fund transfer from a banking institution (e.g., an automatic clearing house (ACH) transfer), for example. Similarly, the group billing system may transfer funds to the third party (e.g., a service provider) via any suitable fund transfer technique. In one example embodiment, for example, funds from the individual contributors to the bill may be loaded by the group billing system onto a fund transaction card, such as a prepaid debit or credit card. The group billing system may then use the fund transaction card to provide payment to the third party. In some example embodiments, as discussed in more detail below, the group billing system may generally include, combine or otherwise connect a bill division and group payment platform with an electronic bill presentment and payment (“EBPP”) platform. The EBPP platform may use, for example, a biller-direct approach or a bank-aggregator approach. For example, an electronic bill may be received directly from a service provider (biller-direct) or it may received via a financial institution (bank-aggregator). In any event, electronically received bills may be processed, divided, and electronically paid in accordance with the systems and methods described herein.

In some example embodiments, the fund transaction card is a “virtual” prepaid credit card, meaning that it is not a physical credit card. Nevertheless, the group billing system can load the virtual prepaid credit card with funds from the users and electronically pay third parties with the prepaid credit card. In some example embodiments, if the group billing system may generate a check, money order, electronic fund transfer (e.g., an ACH transfer), standard card transaction, or other type of payment that can be delivered to the third party, such as a landlord, for example. Such an approach may be used in situations where the third party does not accept payment via a credit card.

The presently disclosed system and methods also may allow for a group of individuals to divide other types of bills or expenses, such as a bill associated with a social event (e.g., a restaurant bill), retail purchases, or travel expenses, for example. As discussed in more detail below, a first user may pay the bill and then enter information about the bill into the group billing system, such as via a user interface, for example. The user interface may be displayed on a web-enabled device, such as a personal computer or a smart phone, for example. The first user may provide an indication to the group billing system which other users owe money on the bill. In some situations, the group billing system may divide up the bill evenly amongst the other users. In other situations, the group billing system may divide up the bill unevenly amongst the other users, with the division determined by at least one user of the system. The present disclosure is not limited to any particular number of other users. For example, in some example embodiments, there may be one other user, ten other users, or 3,000 other users. In any event, the group billing system may provide a notification (an email, a text message, an automated voicemail, or web-based notification, for example) to the other users regarding their share of the bill. As discussed in more detail below, the other users may have the option to accept, deny or otherwise modify their share of the bill. As the group billing system collects funds from the other users (e.g., via electronic fund transfers), the group billing system transfers the funds to the first user who originally outlaid the funds for the bill.

The presently disclosed system and methods also may allow for a person, a group, an organization or other type of entity of manage the real-time (or near real-time) collection of funds for a group bill prior to the payment of the bill. As discussed in more detail below, a group of users may load funds onto a fund transaction card, such as a prepaid card prior to paying the bill. In some example embodiments, web-enabled devices, such as a laptop, a netbook, a smart phone, a PDA, or other electronic devices may be used by the users to remotely load funds onto the fund transaction card. The amount of funds provided by each user may vary based on their share of the bill. Once sufficient funds have been loaded onto the fund transaction card, the card may then be physically provided to a third party to pay for the bill.

The presently disclosed system and methods also may allow for an organization or other type of entity of manage the collection of funds, such as for membership dues, donations, or other types of fees, expenses, and payments. As discussed in more detail below, the group billing system may provide a notification to at least some of the members of the group that an amount of funds is owed by each member. Each member may then provide the funds through the group billing system interface. The group billing system may then transfer the funds received by each member to the organization. For example, a particular group or entity may have a yearly $50 membership fee. Each member of the group may have a different payment cycle that is based on the date on which the particular member joined. The group billing system may track the amount owed for each individual member and provide individual notifications at the appropriate time periods. Upon receiving the notification, the individual member may transfer funds to the group billing system from their bank account, for example. The group billing system may provide an up-to-date accounting of the status of each member's account to a financial manager of the group. As is to be appreciated, the group billing system could also be used for a variety of other expenses generated by a group or entity.

Generally, the presently disclosed system and methods allow for a wide variety of bills, fees, and expenses to be paid by a plurality of users. For the purposes of illustration, the present disclosure will largely be described in the context of a bill with an amount that is owed by a plurality of users to a third party or provider. Thus, while the term “bill” is used below, the disclosure is not limited to any particular type of bill. Instead, the “bill” in the various embodiments may refer to any type of fees, dues, charges, or funds that are owed or otherwise provided to a third party. The “users” referred to in the embodiments below are not limited to any particular type of user of the systems and methods disclosed herein. The users may be individuals, entities, or any other type of party that is to provide a share to an outstanding bill. Further, as used below, the providers and third parties referred to in the various embodiments are not limited to any particular type of entity. For example, the entity may be an individual, a group of individuals, a group, a charity, a governmental entity, a club, a company, a service provider, or any other party to which funds are owed. In some example embodiments, the third party is one or more users of the group billing system.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

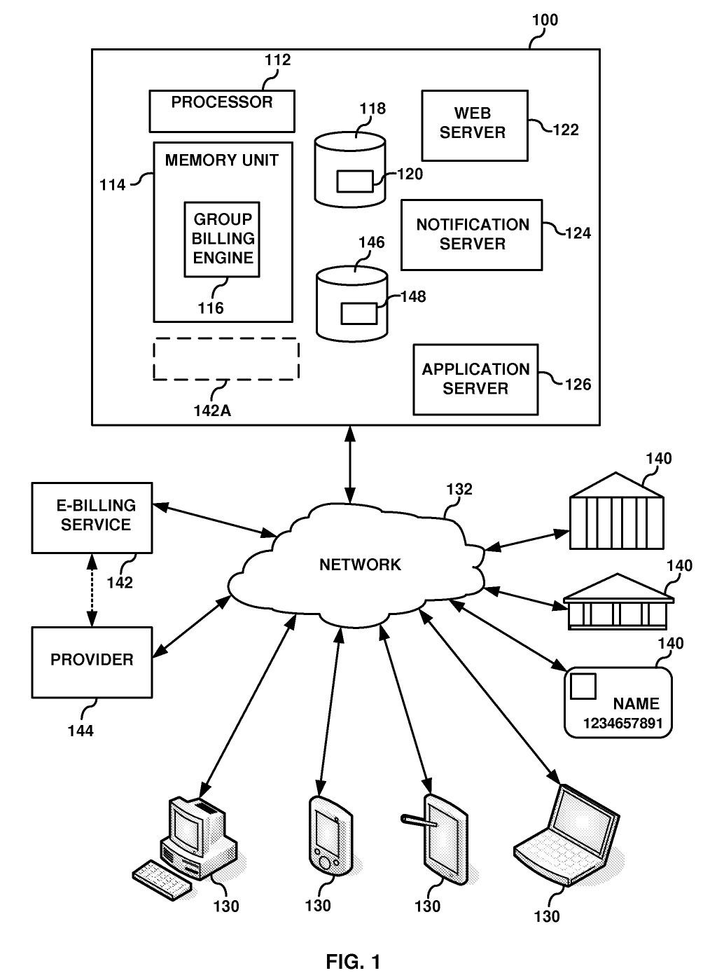

Referring now to FIG. 1, one example embodiment of the present disclosure may comprise a computer-based group billing system 100 that receives and processes group billing information. The group billing system 100 may be provided using any suitable processor-based device or system, such as a personal computer, laptop, server, mainframe, or a collection (e.g., network) of multiple computers, for example. The group billing system 100 may include one or more processors 112 and one or more computer memory units 114. For convenience, only one processor 112 and only one memory unit 114 are shown in FIG. 1. The processor 112 may execute software instructions stored on the memory unit 114. The processor 112 may be implemented as an integrated circuit (IC) having one or multiple cores. The memory 114 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

The memory unit 114 may store executable software and data for a group billing engine 116. When the processor 112 of the group billing system 100 executes the software of the group billing engine 116, the processor 112 may be caused to perform the various operations of the group billing system 100, such as divide bills among users, provide notifications to users, receive fund transfers from users, and provide fund transfers to third parties, as discussed in more detail below. Data used by the group billing engine 116 may be from various sources, such as a bill database 118, which may be an electronic computer database, for example. The data stored in the bill database 118 may be stored in a non-volatile computer memory 120, such as a hard disk drive, a read only memory (e.g., a ROM IC), or other types of non-volatile memory. Also, the data of the bill database 118 may be stored on a remote electronic computer system, for example.

The group billing system 100 may be in communication with user devices 130 via an electronic communications network 132. The communications network 132 may include a number of computer and/or data networks, including the Internet, LANs, WANs, GPRS networks, etc., and may comprise wired and/or wireless communication links. The user devices 130 may communicate with the group billing system 100 and each other via the network 132 any may be any type of client device suitable for communication over the network 132, such as a personal computer, a laptop computer, or a netbook computer, for example. In some example embodiments, a user may communicate with the network 132 via a device 130 that is a combination handheld computer and mobile telephone, sometimes referred to as a smart phone. It can be appreciated that while certain embodiments may be described with users communication via a smart phone or laptop by way of example, the communication may be implemented using other types of user equipment (UE) or wireless computing devices such as a mobile telephone, personal digital assistant (PDA), combination mobile telephone/PDA, handheld device, mobile unit, subscriber station, game device, messaging device, media player, pager, or other suitable mobile communications devices.

The user device 130 may provide a variety of applications for allowing a user to accomplish one or more specific tasks using the group billing system 100. Applications may include, without limitation, a web browser application (e.g., INTERNET EXPLORER, MOZILLA, FIREFOX, SAFARI, OPERA, NETSCAPE NAVIGATOR) telephone application (e.g., cellular, VoIP, PTT), networking application, messaging application (e.g., e-mail, IM, SMS, MMS, BLACKBERRY Messenger), contacts application, calendar application and so forth. The user device 130 may comprise various software programs such as system programs and applications to provide computing capabilities in accordance with the described embodiments. System programs may include, without limitation, an operating system (OS), device drivers, programming tools, utility programs, software libraries, application programming interfaces (APIs), and so forth. Exemplary operating systems may include, for example, a PALM OS, MICROSOFT OS, APPLE OS, UNIX OS, LINUX OS, SYMBIAN OS, EMBEDIX OS, Binary Run-time Environment for Wireless (BREW) OS, JavaOS, a Wireless Application Protocol (WAP) OS, and others.

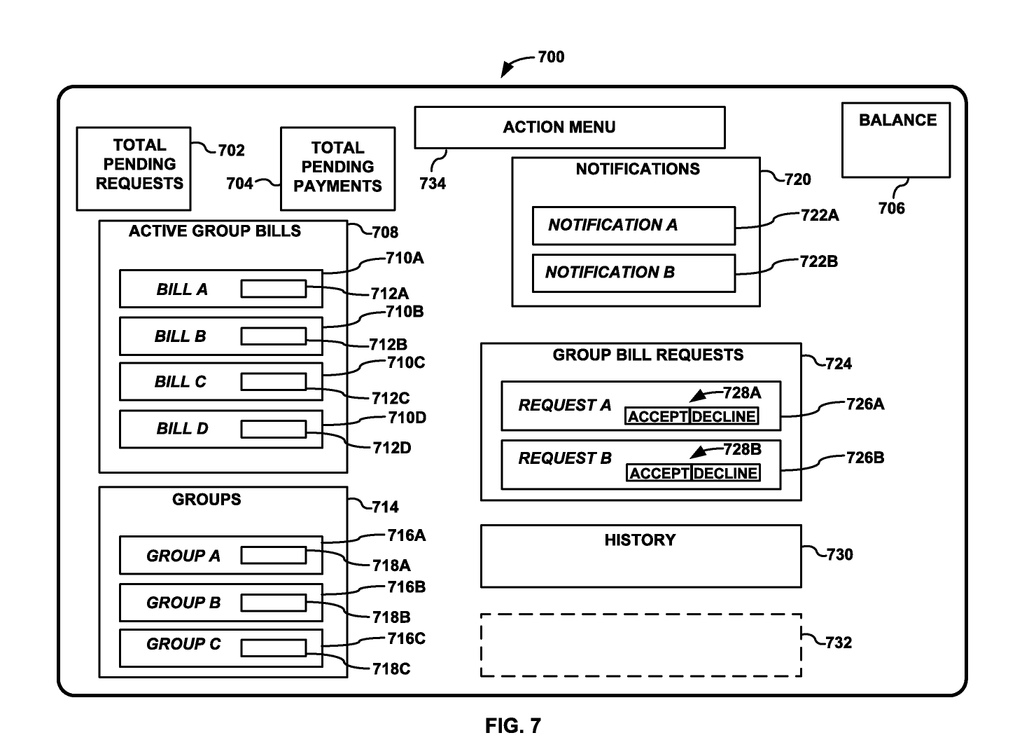

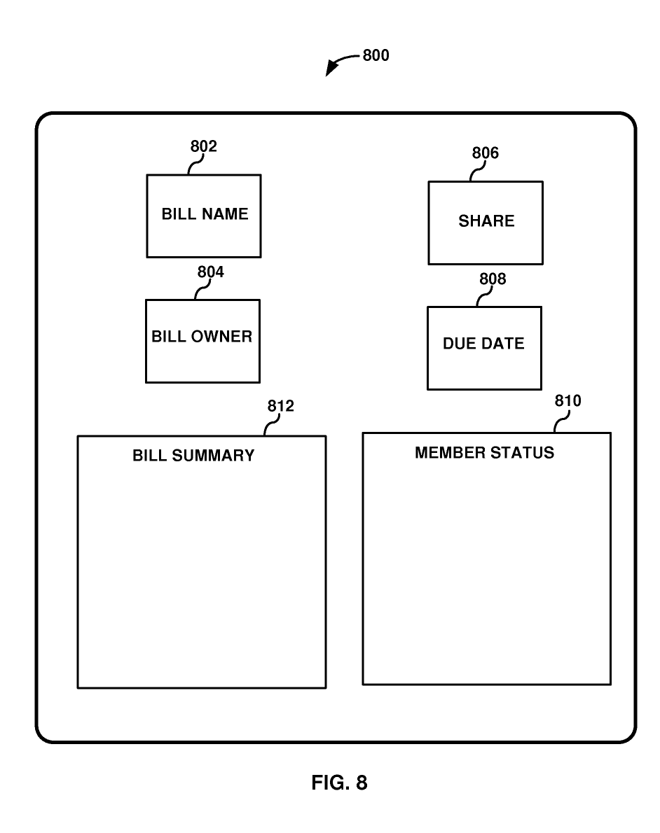

In general, an application may provide a user interface to communicate information between the group billing system 100 and the users via user devices 130. The user devices 130 may include various components for interacting with the application such as a display for presenting the user interface and a keypad for inputting data and/or commands. The user devices 130 may include other components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, a camera, and so forth. Example user interfaces are shown in FIGS. 7-8, which are described further below. Through the interface, the users may interact with the group billing system 100 (e.g., create group bills, transfer funds, create groups, receive notifications, review payment history, etc.). Additionally, users may interact with the group billing system 100 via a variety of other electronic communications techniques, such as email messages and short message service (SMS) messages. In some example embodiments, a user may be perform a variety of functions through email and/or SMS communications, such as create bills, accept bills, decline bills, and send group messages, for example.

The applications may include or be implemented as executable computer program instructions stored on computer-readable storage media such as volatile or non-volatile memory capable of being retrieved and executed by a processor to provide operations for the user devices 130. The memory may also store various databases and/or other types of data structures (e.g., arrays, files, tables, records) for storing data for use by the processor and/or other elements of the user devices 130.

As shown in FIG. 1, the group billing system 100 may include several computer servers and databases. For example, the group billing system 100 may include one or more web servers 122, notification servers 124, and application servers 126. For convenience, only one web server 122, one notification server 124, and one application server 126 are shown in FIG. 1, although it should be recognized that the invention is not so limited. The web server 122 may provide a graphical web user interface through which users of the system may interact with the group billing system 100. The web server 122 may accept requests, such as HTTP requests, from clients (such as web browsers on the device 130), and serve the clients responses, such as HTTP responses, along with optional data content, such as web pages (e.g., HTML documents) and linked objects (such as images, etc.).

The application server 126 may provide a user interface for users who do not communicate with the group billing system 100 using a web browser. Such users may have special software installed on their end-user devices 130 that allows them to communicate with the application server 126 via the network 132. Such software may be downloaded, for example, from the group billing system 100, or other software application provider, over the network to such user devices 130. The software may also be installed on such user devices 130 by other means known in the art, such as CD-ROM, etc.

The user interface provided by the web server 122 or the application server 126, as the case may be, as described further below, may permit users via user devices 130 to communicate with each other in real-time using Asynchronous JavaScript and XML (AJAX) web development techniques, for example. In other embodiments, the group billing system 100 may provide, in addition or in the alternative, other mechanisms for real-time communication, such as instant messaging. For embodiments that provide instant messaging, the group billing system 100 may include an instant messaging server (nor shown) for handling the instant messaging communications between the users. In some example embodiments, the web server 122 may provide posts of billing-related messages and/or links to social networking websites or applications.

The notification server 124 may cause notifications, such as emails, text messages, smart phone notifications, phone calls, or other types of communications, to be sent to the end user devices 130 via the network 132 and to track/store the notifications. More details regarding the notification server 120 are provided below.

The servers 122, 124, 126 may comprise processors (e.g., CPUs), memory units (e.g., RAM, ROM), non-volatile storage systems (e.g., hard disk drive systems), etc. The servers 122, 124, 126 may utilize operating systems, such as Solaris, Linux, or Windows Server operating systems, for example.

Although FIG. 1 depicts a limited number of elements for purposes of illustration, it can be appreciated that the group billing system 100 may include more or less elements as well as other types of elements in accordance with the described embodiments. Elements of the group billing system 100 may include physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

In addition to the end user devices 130, the group billing system 100 may be in communication with other entities, such as a financial institutions 140, an e-billing service provider 142, and a provider 144. In various embodiments, the provider may be a third party service provider or a user of the group billing system 10, for example. Through the network 132 and user devices 130, users may selectively transfer funds from a financial institution 140 into the group billing system 100. The financial institution 140 may be a bank or a credit card company, for example. User funds from the financial institution 140 may be transferred into the group billing system 100 using any suitable fund transfer technique, such as by checking account and routing number information provided to the group billing system 100 by the user. In some example embodiments, a user may transfer funds into the group billing system 100 from a credit card account associated with financial institution 140. As discussed in more detail below, fees may be collected by the group billing system 100 when funds are transferred. The received funds may be stored by the group billing system 100 in an account database 146, for example. In one example embodiment, each user has an account 148 in the account database 146 to which the individual user may deposit funds from any suitable source. The process of transferring funds in and out of the account 148 may be accomplished by the user through a user interface on the user device 130, for example. In one example embodiment, all of the funds in the user's account 148 are stored on a prepaid debit card, a prepaid credit card, a prepaid gift card, or other form of prepaid payment vehicle (referred to herein as a “prepaid card”). The user may transfer funds in and out of the account as needed and pay for bills with funds on the prepaid credit card. In some example embodiments, the account 148 is maintained by an entity separate from the group billing system 100, such as a prepaid card provider. Nevertheless, the group billing system 100 may transfer funds in and out of the account 148 as required. In some example embodiments, funds in a user's account are held in escrow by the group billing system 100, or other associated system. In some example embodiments, a user's account may include some funds that are stored on a prepaid card and some other funds that are held by the group billing system 100 (e.g., held in escrow). For example, the user may be able to selectively transfer funds from an escrow account to the prepaid card, and vice versa.

The group billing system 100 may also communicate with the provider 144 such that funds may be transferred from the group billing system 100 into accounts associated with the provider 144. In some example embodiments, funds are transferred to the provider 144 via a fund transaction card, such as a prepaid card. In other embodiments, funds may be transferred from the group billing system 100 to the provider 144 using other transfer techniques, such as via a direct deposit into a banking account, via a check, or via a money order, for example.

The e-billing service provider 142 may be any suitable bill servicing platform and/or site scraping service that retrieves or otherwise gathers billing information. In one example embodiment, the e-billing service provider 142 is FIDELITY INFORMATION SERVICES, INC. In some embodiments, the group billing system 100 includes the e-billing service provider, as indicated by internal e-billing service provider 142A. In any event, the e-billing service provider 142 may communicate billing information between the provider 144 and the group billing system 100. In some example embodiments, payment to the provider 144 may be through the e-billing service provider 142.

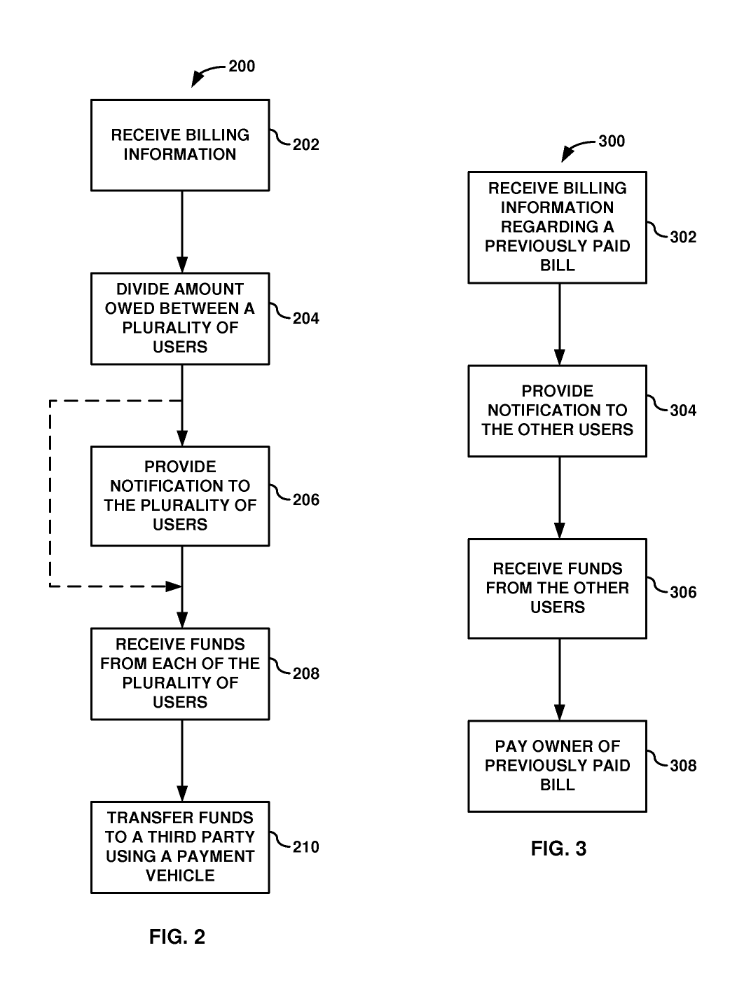

FIG. 2 illustrates a group billing process 200 in accordance with one non-limiting embodiment. The group billing process 200 may be executed, at least in part, by the group billing engine 116 (FIG. 1). At block 202, billing information may be received by the group billing system 100. As discussed above, the billing information may be associated with any type of bill, such as a rent bill, a utility bill, membership dues, or a social bill, for example. The billing information may be stored in the bill database 118. The billing information may be provided directly from a user (referred to herein as the “owner” of the bill) via the user device 130. Alternatively, the billing information may be provided from the e-billing service provider 142, for example, or from another source. In some example embodiments, receiving the billing information at block 202 may include actively retrieving the billing information. In some example embodiments, the billing information may include an amount owed, a minimum payment due, an account number, an account holder name, a third-party payor (e.g., the service provider), and a due date.

At block 204, the group billing system 100 divides the amount owed between a plurality of users. The particular division of the amount owed may vary based on the type of bill, or other parameters. For example, the group billing system 100 may equally divide a rent bill among a set of users (e.g., the roommates) while other bills may be divided unequally among a set of users. In some example embodiments, the bill owner may provide the desired apportionment of the bill to the group billing system 100 via the user interface when the billing information is provided. As is to be appreciated, even if the amount owed is divided equally among a set of users, the individual amounts owed may slightly vary due to rounding.

At block 206, the group billing system 100 may provide a notification to the plurality of users. The notification may be provided in a wide variety of forms. In one example embodiment, the notification is an electronic message that is transmitted to a user device 130 by the notification server 124. The notification may take the form of a text message, an email message, an automated voicemail, or any other suitable form of notification. In one example embodiment, the notification is provided to the user via the user interface. For example, when the users access the user interface via the user device 130, the user interface provides an itemized list of the outstanding bills and the amount that each user owes for each bill.

In some example embodiments, the group billing process 200 may proceed from block 204 to block 208 without providing a notification, as indicated in FIG. 2. For example, automatic bill payment may have been authorized by one or more of the users for a particular bill. In such situations, the group billing system 100 may not send a notification to the user prior to payment. As is to be appreciated, however, some users may wish to receive notifications even if automatic bill payment has been authorized.

At block 208, the group billing system 100 may receive funds from each of the plurality of users. For example, the total bill may be for $30 which is divided evenly between three users (e.g., the bill owner and two other users). In some situations, a user may have $10 in its account 148 to cover the amount owed on the bill. In that case, funds will be transferred from that user's account into the account of the bill owner. In other situations, the user may have to transfer additional funds into the group billing system 100, such as from the financial institution 140. The additional funds may be added to that users account (e.g., loaded onto that user's prepaid card), or added directly to the bill owner's account. If the bill owner already has $10 in their account no further action is required. If, however, their account has a balance of less than $10, additional funds will need to be provided by the bill owner to the group billing system 100. Ultimately, the bill owner will have a total of $30 loaded into their account (e.g., loaded onto their prepaid card), plus or minus any applicable fees.

At block 210, the group billing system 100 may transfer the collection of funds received from the users to the third party using a payment vehicle. The payment vehicle may be, without limitation, a prepaid card, a credit card, a charge card, a debit card, a check, a money order, an electronic check, a gift card, contactless payment sticker (e.g., GO-tag), SIM card, or any other suitable type of payment vehicle. In some example embodiments, the payment vehicle may be a virtual payment vehicle that does not have a physical representation. In some example embodiments, the payment vehicle may be a physical payment vehicle, which may be provided to the third party for payment. In some example embodiments, block 212 is at least partially performed by the e-billing service provider 142. In any event, the group billing system 100 may directly or indirectly provide funds to the third party, wherein the funds were received from a plurality of users.

In some example embodiments, the group billing system 100 may accommodate for situations where at least one user does not pay their share of the bill. For example, the group billing system 100 may provide a notification to the bill owner that another user (e.g., a non-paying user) has not supplied the necessary funds to satisfy their share of an obligation. The group billing system 100 may present various options to the bill owner, such as pay the bill without the non-paying user's share or cover the non-paying user's share with funds from the bill owner and/or other users, for example.

FIG. 3 illustrates a group billing process 300 for a previously paid bill in accordance with one non-limiting embodiment. The group billing process 300 may be executed, at least in part, by the group billing engine 116 (FIG. 1). At block 302, billing information is received for a bill which has already been paid. The billing information may be associated with any type of bill, such as a rent bill, a utility bill, an entrance fee, membership dues, a donation, or a social bill, for example, which has already been paid by a user (referred to herein as the “owner” of the bill). The owner may provide the billing information via a user interface on a user device 130, for example. In some example embodiments, the billing information may comprise an amount owed to the owner, a due date, the names of other users who owe the owner funds, and the shares owed by each user.

At block 304, the group billing system 100 may provide a notification to the users who owe the owner funds based on the previously paid bill. As provided above, the notification may be provided in a wide variety of forms and is not limited any particular type or form of notification. In some example embodiments, upon receiving a notification, a user may “accept” or “decline” the apportionment of the bill.

At block 306, the group billing system 100 may receive funds from the other users. Similar to block 208, the other users may have enough funds in their accounts 148 to cover the amount owed on the bill. In other situations, the other users may have to transfer additional funds into the group billing system 100, such as from the financial institution 140.

At block 308, the group billing system 100 may pay the owner via any suitable payment technique. In some example embodiments, the group billing system 100 may pay the owner by transferring funds into the owner's account 148. The funds may be transferred from another user's prepaid account, for example. If the other user does not have an account, the other user may transfer funds from a financial institution 40 into the owner's account 148. The owner make keep the funds in the account 148 (e.g., keep the funds on their prepaid card) for payment of future bills or the owner may transfer the funds from the account 148 into their checking account at a financial institution, for example. In some example embodiments, the group billing system 100 may pay the owner by generating a check or money order payable to the owner.

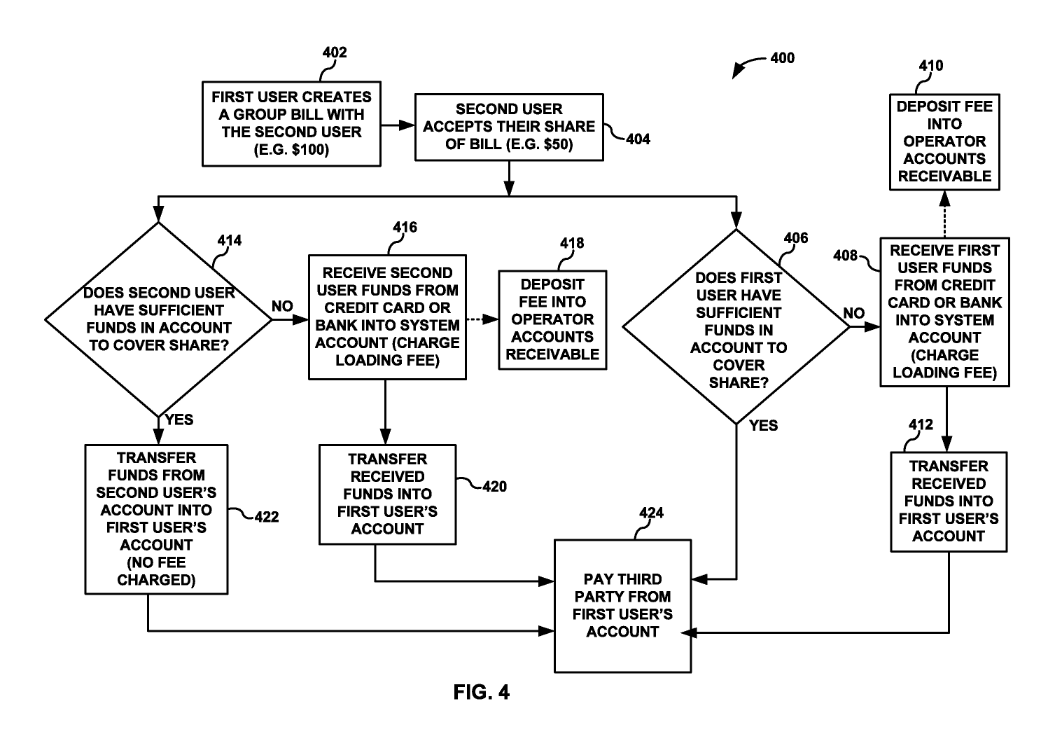

In some example embodiments, a fee may be charged by the operator of the group billing system 100. FIG. 4 illustrates a group bill payment process 400 which includes a fee structure in accordance with one non-limiting embodiment. At block 402, a first user creates a group bill with a second user. In the illustrated embodiment, the amount owed on the group bill is $100 owed to a third party, with each user owing $50. At block 404, the second user accepts their share of the group bill. In this embodiment, the first user is the “owner” of the group bill and will ultimately pay the third party through their account 148, which may be a prepaid card, for example. The first user may create the group bill through interaction with the group billing system 100 through a user device 130.

At block 404, the second user accepts their share of the group bill. In the illustrated embodiment, the second user's share of the group bill is $50.00. As is to be appreciated, at block 404 the second user may alternatively decline the group bill or alter the division of the group bill and request the first user to accept the new division of the group bill. Furthermore, while the illustrated embodiment in FIG. 4 involves a first user and a second user, it is to be appreciated that a similar process may be used for a plurality of users, with each user independently accepting their share of the group bill.

At block 406, the group billing system 100 determines if the first user has sufficient funds (e.g., at least $50.00) in their account to cover their share of the group bill. If the first user does not have sufficient funds, the first user may load additional funds into their account at block 408. As provided above, the funds may be received from a variety of sources, such as from a credit card company or from a bank account. In some example embodiments, a loading fee is charged by the operator of the group billing system 100. The loading fee structure may, for example, be a flat fee per load or be based on a percentage of the load amount. In other words, if the first user loads $50 into their account from a checking account. $51.00 may be received into an operator's account associated with the group billing system 100. The $1.00 loading fee may be deposited in an operator's accounts receivable at block 410. At block 412, the remaining $50.00 may be transferred into the first user's account. As is to be appreciated, the first user may opt to load an amount of funds greater than their share owed on the group bill. For example, although the first user owes $50.00 in the illustrated embodiment, the first user may wish to load $150.00 into their account so they have funds available for future transactions. In one example embodiment, a $3.00 loading fee may be charged to load $150.00 into the account. Furthermore, the present disclosure is not limited to any particular fee arrangement. For example, in one embodiment, $51.00 may be transferred into the first user's account with the $1.00 loading fee subsequently transferred from the first user's account to an operator's accounts receivable.

At block 414, the group billing system 100 determines if the second user has sufficient funds (e.g., at least $50.00) in their account to cover their share of the group bill. If the second user does not have sufficient funds, the second user may load additional funds into the group billing system 100 at block 416. As described above, a loading fee is charged by the operator of the group billing system 100. The loading fee may be deposited in an operator's accounts receivable at block 418. At block 420, the funds received by the group billing system may be transferred into the first user's account. If the second user loads an amount of funds into the group billing system 100 that exceeds their share of the group bill, the excess may be deposited into the second user's account (e.g., loaded onto their prepaid card).

If it is determined at block 414 that the second user has sufficient funds in their account (e.g., at least $50.00), at block 422 the funds are transferred from the second user's account to the first user's account. In some example embodiments, the transfer is affected by transferring funds from a prepaid card associated with the second user to a prepaid card associated with the first user. Additionally, in some example embodiments, no fee is charged for this transaction since the operator previously received fees when the funds were originally loaded into the second user's account.

Now that there are sufficient funds in the first user's account, at block 424 the third party is paid with funds from the first user's account. As discussed above, the third party may be paid via the prepaid card associated with the first user. In some example embodiments, the third party may receive payment through the e-billing service provider 142, for example.

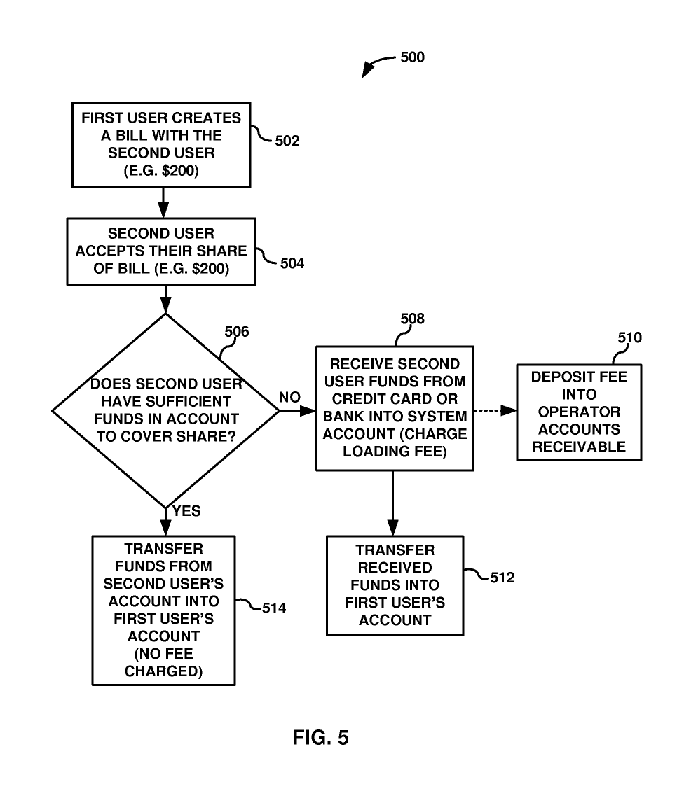

In some example embodiments, the group billing system 100 may be used to provide person-to-person payments. FIG. 5 illustrates a group bill payment process 500 which includes a fee structure in accordance with one non-limiting embodiment. At block 502, a first user creates a bill with a second user. In the illustrated embodiment, a second user owes the first user $200. At block 504, the second user accepts their share of the bill (e.g., $200). The first user may create the bill and the second user may accept their share of the bill through interaction with the group billing system 100 through user devices 130, for example. In some example embodiments, rules of trust may be established by a user to help automate the bill acceptance process. For example, a user may pre-accept all bills from a particular individual or a particular group.

At block 506, the group billing system 100 determines if the second user has sufficient funds (e.g., at least $200.00) in their account to cover their share of the bill. If the second user does not have sufficient funds, the second user may load additional funds into the group billing system 100 at block 508. As described above, a loading fee is charged by the operator of the group billing system 100. The loading fee may be deposited in an operator's accounts receivable at block 510. At block 512, the funds received by the group billing system may be transferred into the first user's account. As discussed above, the present disclosure is not limited to any particular fee arrangement. For example, in one embodiment, $200.00 plus the loading fee may be transferred into the first user's account with the loading fee subsequently transferred from the first user's account to an operator's accounts receivable. In other embodiments, other fee arrangements may be used, such as bill pay fees, withdrawal fees, and/or receiver fees, for example.

If it is determined at block 516 that the second user has sufficient funds in their account (e.g., at least $200.00), at block 514 the funds are transferred from the second user's account to the first user's account. In some example embodiments, the transfer is affected by transferring funds from a prepaid card associated with the second user to a prepaid card associated with the first user.

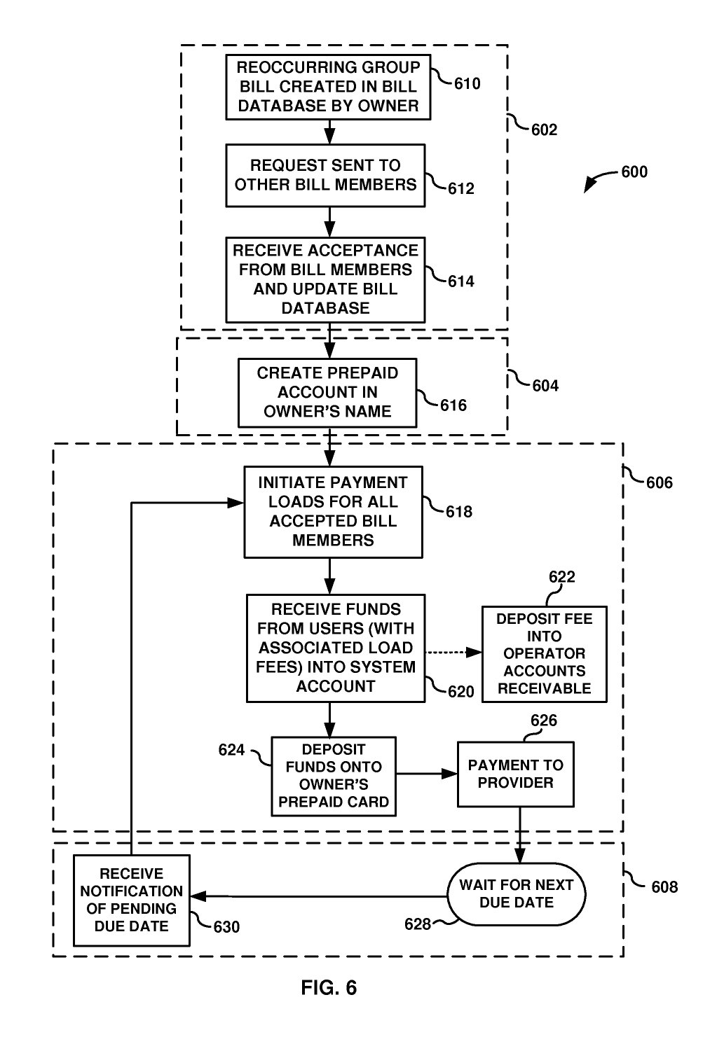

FIG. 6 illustrates a group billing process 600 with a reoccurring group bill in accordance with one non-limiting embodiment. The group billing process 600 may include a plurality of segments or portions. In one example embodiment, the group billing process 600 comprises a bill creation portion 602, a prepaid account setup portion 604, a bill payment portion 606, and a waiting portion 608.

Referring first to the bill creation portion 602, at block 610 an owner of a reoccurring group bill may create a group bill in the bill database 118. In some example embodiments, the bill creation portion 602 includes interaction with the e-billing services provider 142. For example, the owner may interact with the e-billing services provider 142 to search and select a third party (e.g., a service provider). The owner may provide account information, an account name, an address associated with the account, and any other required information during the bill creation portion 602. At block 612, the owner may send a bill request to other members of the reoccurring group bill. At block 614, acceptances may be received from the other members and the bill database 118 may be updated accordingly.

Moving now to the prepaid account setup portion 604, at block 606 a prepaid account may be opened in the bill owner's name. In some example embodiments, the prepaid account may be a prepaid card, such as a prepaid VISA card. While a prepaid account may be created in the bill owner's name, the bill owner may not physically receive an associated card. Instead, the account may only exist “virtually.”

Moving now to the bill payment portion 606, at block 618 payment loads for all accepted members of the group bill is initiated by the group billing system 100 based on a pending due date for the reoccurring group bill. At block 620, funds may be received from the members of the group bill into the system account. As provided above, funds received may include a transaction fee which may be subsequently deposited into the operator's accounts receivable at block 622. The funds received from the members of the group bill may only reside in the system account briefly before being transferred to the bill owner's prepaid account. The prepaid account may be held by a third party. In some example embodiments an escrow account associated with the system is used in lieu of or in addition to a user's prepaid account. At block 626, payment may be provided to the third party from the bill owner's prepaid account. As is to be appreciated, a process similar to the process 600 may be used for reoccurring person-to-person payments. In person-to-person embodiments, however, payment is not provided to a provider at block 626. Instead, the funds would remain in the owner's account (e.g., on the owner's prepaid card).

After payment of the bill, the example procedure may move to the waiting section 608. At block 628 the system may wait for the next bill due date. The due date information may be stored in the bill database 118 or be supplied from the e-billing service provider 142, for example. The length of the waiting period may vary from bill to bill. For some bills, the waiting period may be about a month, while other bills may have a waiting period of about 6 months, one year, or longer, for example. At block 630, notification of an upcoming due date for the reoccurring group bill is received by the group billing system 100. The notification may come from the e-billing service provider 142, the bill database 118, or any other source. The process may then return to the bill payment section 606.

FIGS. 7-8 show screen shots of a user interfaces 700 and 800 that a member of the group bill (and/or other users) may view when they access the group billing system 100 from their user devices 130. The user interfaces 700 and 800 may be provided by the web server 122 or the application server 126, as the case may be, depending on the user's access method.

As shown in FIG. 7, in one example embodiment, the user interface 700 provides a dashboard to convey a wide variety of information to the user. It is to be appreciated, however, that the present disclosure is not limited to the arrangement and content of user interface 700 illustrated in FIG. 7.

The user interface 700 may include a total pending requests field 702 and a total pending payments field 704. The total pending request field 702 may provide a tally of the user's share of the group bills that have yet to be accepted by the user. The total pending payments field 704 may provide the total number of funds that will be paid within an upcoming time period (e.g., 7 days or 1 month). A balance field 706 may provide the user with the amount of funds available to the user (e.g., the user's balance on a prepaid card). The user may compare the total pending payments field 704 to the balance field 706 to ensure that they have sufficient funds in their account to cover the upcoming payments.

The user interface 700 may also include a variety of other fields. In one example embodiment, the user interface 700 includes an active group bills field 708 which may include active bill fields 710A-D. The active bill fields 710A-D may include a bill information field 712A-D which may provide the user with the amount owed and the due date, for example.

In one example embodiment, the user interface 700 may include a groups field 714 which may include group name fields 716A-C informing the user as to which groups they belong. The group name fields 716A-C may include a group information field 718A-C which may provide the user with the number of members and the number of bills associated with each group, for example.

In one example embodiment, the user interface 700 may include a notifications field 720 which may include individual notification fields 722A-B. The individual notification fields 722A-B may provide information to the user, such as upcoming due dates, the status of pending group bill requests. As provided above, notifications may also be provided to the user via other forms, such as e-mails and/or text messages, for example.

In one example embodiment, the user interface 700 may include a group bill requests field 724 which may include requests fields 726A-B. The request fields 726A-B may include a buttons 728A-B, such as an “accept” button and a “decline” button.

In one example embodiment, the user interface 700 may include a history field 730 which may provide the user an overview of past payment activity.

In one example embodiment, the user interface 700 may include an action menu 734 with which the user may initiate varies actions, such as generating a new group bill, generating a new group, and loading funds into the account, for example.

In various embodiment, the user interface 700 may include additional fields, indicated by field 732 which may provide the user additional information or functionality.

Referring now to FIG. 8, the user interface 800 provides a information about a particular group bill. The user interface 800 may be presented to a user if that user was identified by the bill owner as a member of the billing group. In one example embodiment, the user interface 800 may include a bill name field 802, and a bill owner field 804. The user interface may also provide the share of the group bill owed by the user in share field 806. The user interface 800 may also the due date in a due date field 808. A bill summary section 812 may provide information about the bill to the user and a member status field 810 may provide the user with an overview of the status of the other members of the bill. For example, the member status field 810 may indicate which other members have accepted their share of the bill and whether the other members have paid their share.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A group billing and payment system, comprising:
a group billing system comprising a non-transitory computer readable medium having instructions stored thereon which when executed by a processor cause the processor to:
receive billing information associated with a provider from an electronic billing service, wherein the billing information comprises an amount owed to the provider;
divide the amount owed into at least a first share and a second share, wherein the first share is apportioned to a first user and the second share is apportioned to a second user;
provide at least one notification to at least one of the first and second user;
receive a first payment amount from the first user;
receive a second payment amount from the second user; and
responsive to receiving at least one of the first and second payment amounts, cause a payment vehicle to be loaded with a payment.

2. The group billing and payment system of claim 1, wherein the payment vehicle is a fund transaction card issued by a financial institution, and wherein the non-transitory computer readable medium has instructions stored thereon which when executed by a processor cause the processor to:
cause the loading of the fund transaction card with at least one of the first payment and the second payment; and
cause the transmission of a payment to the service provider via the fund transaction card.

3. The group billing and payment system of claim 2, wherein the fund transaction card is one of a prepaid credit card and a prepaid debit card.

4. The group billing and payment system of claim 1, wherein the first share of the amount owed is different than the second share of the amount owed.

5. The group billing and payment system of claim 1, wherein the notification comprises at least one of an email message and a text message.

6. The group billing and payment system of claim 1, further comprising the electronic billing service.

7. The group billing and payment system of claim 1, wherein the group billing system comprises:
a first funding account associated with the first user;
a second funding account associated with the second user;
wherein the non-transitory computer readable medium has instructions stored thereon which when executed by a processor cause the processor to:
load funds into the first funding account from one of a bank account and a credit card; and
load funds into the second funding account from one of a bank account and a credit card.

8. The group billing payment system of claim 7, wherein at least one of the first and second funding accounts are loaded onto a prepaid card issued by a financial institution.

9. The group billing and payment system of claim 8, wherein the prepaid card is a virtual prepaid card is issued to one of the first user and the second user.

10. The group billing payment system of claim 7, wherein funds associated with each of the first and second funding accounts are held in escrow.

11. A computer-implemented method, comprising:
receiving from an electronic billing service, by a computer system, data indicating an amount owed to an entity;
dividing, by the computer system, the amount owed into a plurality of shares;
receiving, by the computer system, funds from each of the plurality of users;
responsive to receiving the funds, causing, by the computer system, the funds to be loaded onto a payment vehicle; and
responsive to the loading of funds onto a payment vehicle, causing a payment to be made to the entity.

12. The computer-implemented method of claim 11, wherein causing the loading of the funds onto a payment vehicle comprises causing the funds to be loaded onto a prepaid card.

13. The computer-implemented method of claim 11, wherein the entity is one of an individual and a service provider.

14. The computer-implemented method of claim 11, wherein dividing the amount owed into a plurality of shares comprises dividing the amount owed into a plurality of equal shares.

15. The computer-implemented method of claim 11, comprising:
upon dividing the amount owed into a plurality of shares, transmitting, by the computer system, a notification to each of a plurality of users, wherein each user is associated with one of the plurality of shares.

16. The computer-implemented method of claim 11, wherein receiving funds from each of the plurality of users comprises receiving funds from at least on escrow account.

17. A computer-implemented method, comprising:
receiving, by a computer system, a request from a first user to create a group bill, wherein the group bill comprises an amount owed to an entity;
receiving, by the computer system, a set of payees from the first user;
dividing, by the computer system, the amount owed amongst the set of payees;
creating, by the computer system, a prepaid account associated with the first user;
receiving, by the computer system, funds from the at least some of the payees;
upon receiving the funds, transferring, by the computer system, at least some of the funds to the prepaid account of the first user; and
responsive transferring at least some of the funds to the prepaid account of the first user, causing an electronic payment to be made to the entity.

18. The computer-implemented method of claim 17, wherein the set of payees comprises the first user.

19. The computer-implemented method of claim 17, comprising:
receiving, by the computer system, a group bill allocation schedule, wherein the amount owed is divided amongst the set of payees in accordance with the group bill allocation schedule.

20. A system, comprising:
a database storing billing information;
a billing computer system operatively connected to the database; wherein the billing computer system is programmed to:
receive electronic billing information from an electronic billing platform, wherein the billing information indicates the amount owed to a third party;
determine a set of users that each owe at least a share of the amount owed;
receive funds from each of the set of users into a system account;
cause the funds from the system account to be loaded onto a prepaid card; and
cause a payment to be provided to the third party using the prepaid card.

21. A system, comprising:
at least one server;
a billing database in communication with the at least one server;
a system account;
a billing computer system; wherein the billing computer system is in communication with the at least one server and at least one user device via a network;
wherein the billing computer system is in programmed to:
receive an electronic bill, wherein the electronic bill indicates the amount owed to a third party;
store the electronic bill in the billing database;
determine a set of users that each owe at least a share of the amount owed;
provide a notification to at least one of the users via the at least one server;
receive funds from each of the set of users into a system account; and
cause the funds in the system account to be loaded onto a prepaid card.
